(19) United States
(12) Patent Application Publication
(10) Pub. No.: US 2008/0082599 A1
(43) Pub. Date: Apr. 3, 2008

(54) System and method for integrating ads into presentation environments

(76) Inventors: Vladislav Sinaniyev, Flushing, NY (US); Ari Paparo, New York, NY (US); Dritan Suljoti, New York, NY (US); Steven Wolkoff, San Francisco, CA (US)

Correspondence Address: KENYON & KENYON LLP, 1500 K STREET N.W., SUITE 700, WASHINGTON, DC, 20005, US

(21) Appl. No.: 11/528,359

(22) Filed: Sep. 28, 2006

(51) Int. Cl. G06F 15/16

(52) U.S. Cl. 709/201

(57) ABSTRACT

A system and method for serving ads. According to an embodiment, an ad server receives over a network an ad request issued by an application engine on a user computer, the ad request issued by the application engine in connection with processing a content source file specifying in a format required by the application engine how the application engine is to provide a display of content and subsequent to the application engine configuring a security setting of the application engine to allow the ad server to serve one or more ads into the content display, and providing an ad source file over the network to the user computer in response to the ad request, the ad source file specifying in the required application engine format how the application engine is to provide a display of an ad.

### BACKGROUND OF THE INVENTION

Internet advertising has gained much steam over the years as an increasing number of consumers rely on the Internet for commerce and browsing. The primary means of advertising to such consumers has entailed the placement of ads, such as banner images, in the content of a web page of a content provider (e.g., a web site providing content accessible via the Internet) requested by a consumer. If the consumer clicked on the image, the browser would direct the consumer to the advertiser's web site. These ads were either hard-coded in the HTML page provided by the content provider, or served into the HTML page by third-party ad servers via HTML links.

However, increases in personal computing platforms and Internet connection speeds have driven the development and utilization of more advanced presentation environments, since HTML was not designed to support the type of rich visual and interactive displays desired by many content providers today.

Such presentation environments are generally implemented by an application engine embedded in a web browser. The application engine, such as the Adobe Flash Player, for example, provides a display pursuant to processing one or more source files—compiled in a format required by the application engine (e.g., an SWF file in the case of Adobe Flash)—specifying how the application engine is to display the content provided therein.

In order to make such a presentation environment available to a consumer, the content provider usually provides a web page referencing the application engine and source file (e.g., via the HTML <object> tag), enabling the consumer's web browser to invoke the application engine to process the appropriate source file. In processing the source file, the embedded application engine displays the content of the source file within a displayable area of the web browser.

It is not uncommon for the content of entire web sites to be programmed and rendered via such presentation environments; however, such sites can provide only limited advertising services that are hard-coded into the sites' content source files.

Accordingly, there is a need in the art for a system and method that improves advertising capabilities of content rendered by advanced presentation environments.

### BRIEF DESCRIPTION OF THE DRAWINGS

FIG. 1 is a block diagram that depicts integration of an ad into a presentation environment in accordance with an embodiment of the present invention.

FIG. 2 is a flow diagram that depicts integration of an ad into a presentation environment in accordance with an embodiment of the present invention.

FIG. 3 is a flow diagram that depicts integration of an ad into a presentation environment via an application programming interface (“API”) in accordance with an embodiment of the present invention.

FIG. 4 is a block diagram that depicts multiple displays areas in accordance with an embodiment of the present invention.

FIG. 5 is a flow diagram that depicts altering of a content display based on a user interaction event in an ad display in accordance with an embodiment of the present invention.

FIG. 6 is a flow diagram that depicts altering of a content display based on queried information received from an ad process in accordance with an embodiment of the present invention.

FIG. 7 is a flow diagram that depicts altering of a content display based on instructions received from an ad process in accordance with an embodiment of the present invention.

FIG. 8 is a flow diagram that depicts altering of an ad display based on a user interaction event in a content display in accordance with an embodiment of the present invention.

FIG. 9 is a flow diagram that depicts altering of an ad display based on queried information received from a content process in accordance with an embodiment of the present invention.

FIG. 10 is a flow diagram that depicts altering of an ad display based on instructions received from an content process in accordance with an embodiment of the present invention.

FIG. 11 is a flow diagram that depicts reporting ad-related activity to a remote server in accordance with an embodiment of the present invention.

FIG. 12 is a block diagram that depicts a computing device in accordance with an embodiment of the present invention.

### DETAILED DESCRIPTION

The present invention addresses the deficiencies of current solutions by providing a mechanism in which ads—formatted for display within a particular presentation environment—can be served directly into content displayable within the same presentation environment. In this manner, the served ads enjoy the benefits of executing within the presentation environment (e.g., complying with the presentation environment's security restrictions, ability to directly communication with the content via an API, etc.) without having to originate from the content itself.

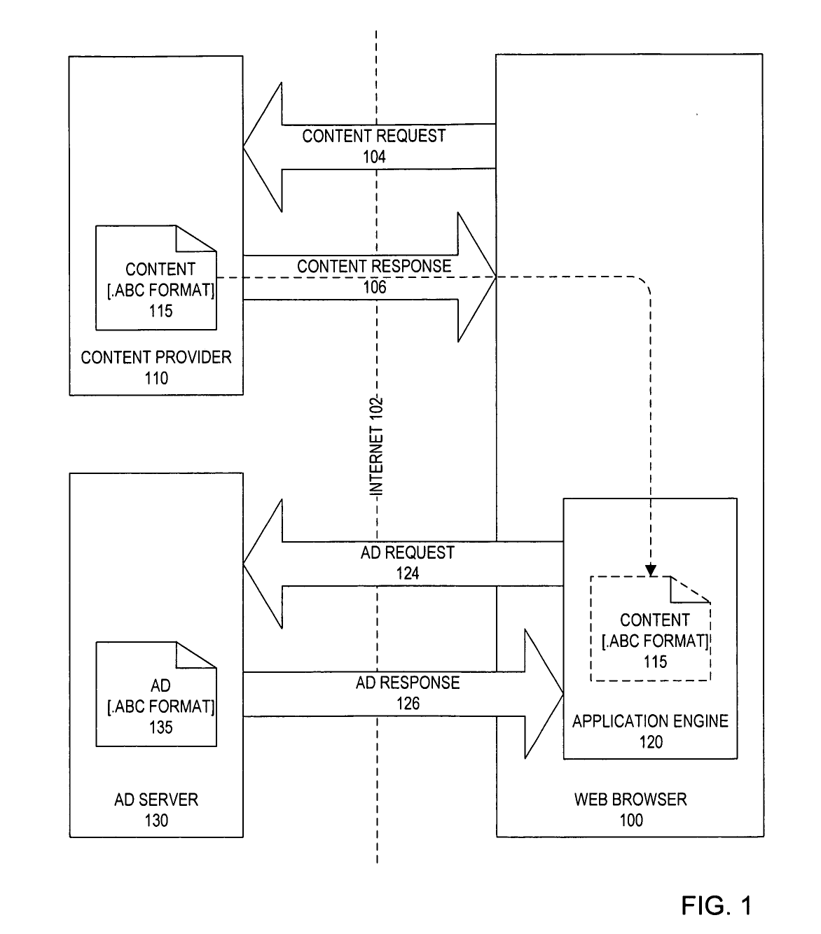

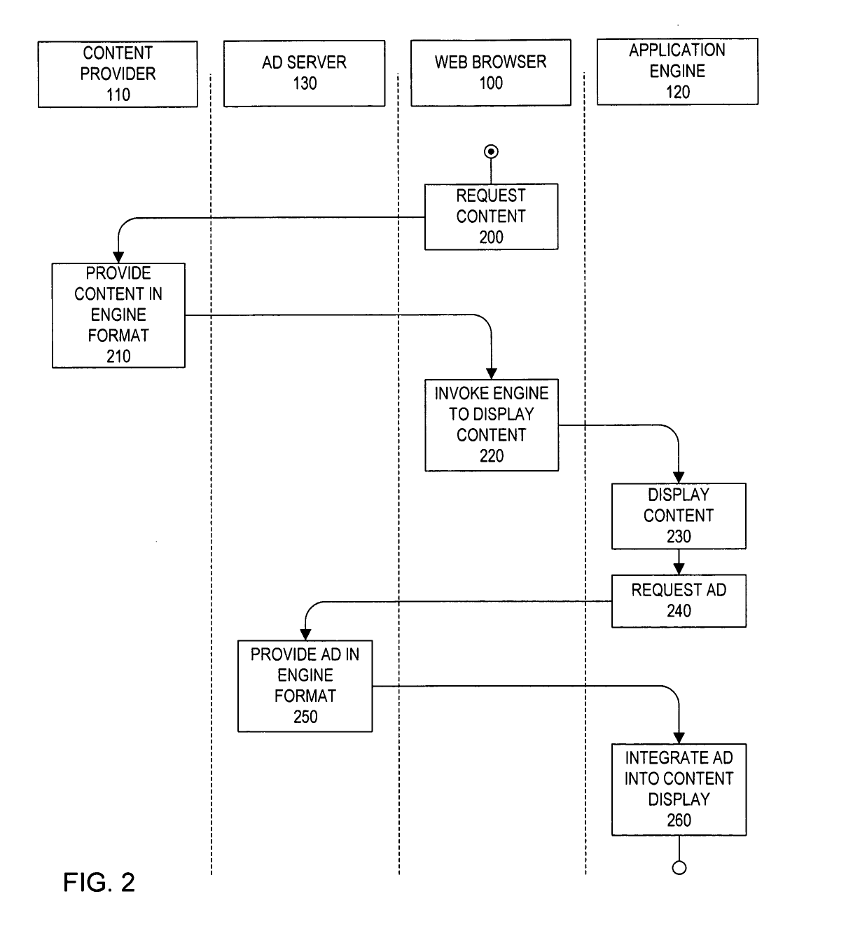

FIGS. 1 and 2 illustrate this mechanism in accordance with an embodiment of the present invention. Upon a web browser (100) receiving an instruction to access a content provider (110) such as a web site (e.g., by a user clicking a link or typing in a URL of the web site, for example), the browser (100) sends a request over the Internet (102) to the content provider (110) for its web page. Since the content of the content provider's (110) site is to be rendered via a particular presentation environment, the content provider (110) returns to the browser (100) a web page referencing (e.g., via URL) an application engine (120) and a content source file (115).

Upon receiving and processing this web page, the browser (100) understands that the site's content is formatted for display within a particular presentation environment in the referenced content source file (115) and is to be rendered by the referenced application engine (120), which is embedded in the browser (100). If the application engine (120) had not been embedded in the browser (100), the browser (100) could have downloaded it from the appropriate location referenced in the web page.

The browser (100) subsequently sends a content request (104) to the content provider (110) based on the received content source file reference (step 200). The content provider (110) returns (step 210) the requested content source file (115) to the browser (100) in a content response (106). The browser (100) then invokes (step 220) the application engine (120), which processes the content source file (115) to display the content (step 230).

Pursuant to an instruction in the content source file (115), the application engine (120) sends (step 240) an ad request (124) to an ad server (130), which returns (step 250) the requested ad source file (135)—which is formatted for display within the same presentation environment as the content—in an ad response (126). Once received, the application engine (120) integrates (step 260) the ad into the content display pursuant to the instructions provided in the ad source file (135) and content source file (115).

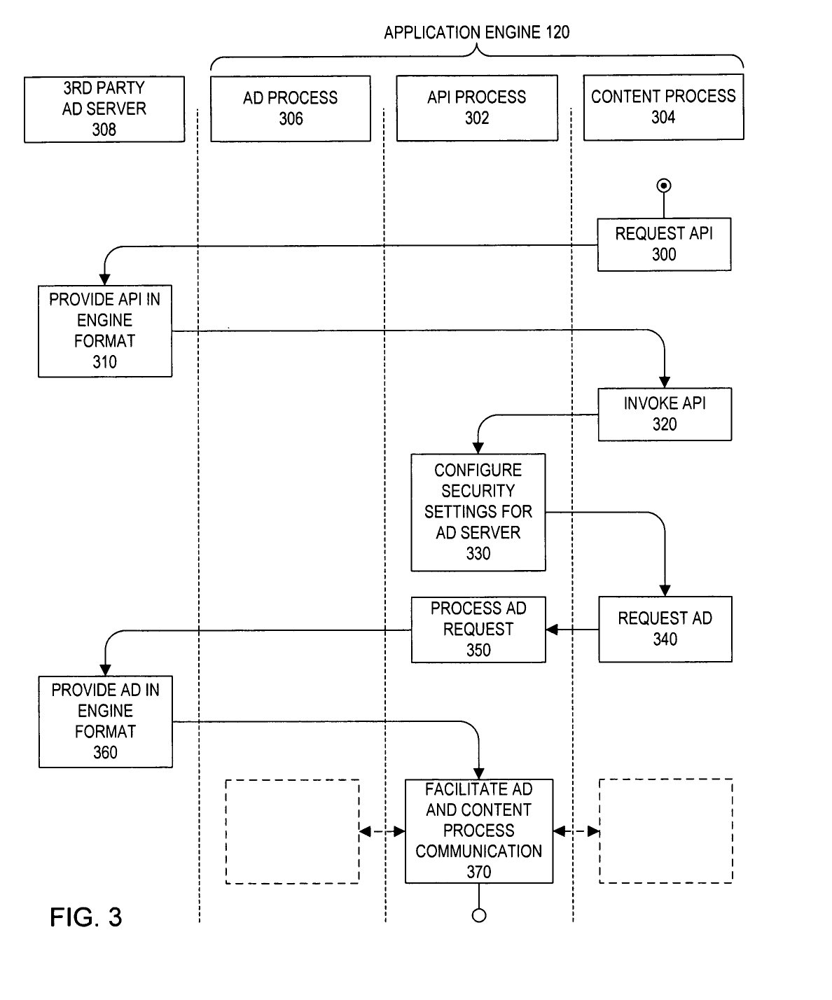

The content provider (110) and ad server (130) may or may not be affiliated with the same network domain. In the case the two are not affiliated (e.g., when the content provider (110) implements third-party advertising via its content), an additional mechanism such as that illustrated in FIG. 3 may be introduced into the process of FIG. 2 before the application engine (120) sends the ad request.

In FIG. 3, a content process (304) (a process run by the application engine (120) pursuant to the processing of the content source file (115)) sends an API request (step 300) to a third party ad server (308), which returns (step 310) the requested API source file in its response.

The API source file specifies how the application engine may implement serving ads from a domain other than that of the content provider (110). For example, the API source file may specify how the application engine is to grant security access to permit downloading of the ad source file (135) from the third party ad server (308), and also how to instantiate a process to facilitate communication in accordance with a pre-defined API between the content process (304) and an ad process (306) (a process run by the application engine 120 pursuant to the processing of the ad source file (135)).

Once the API source file is received by the application engine (120), the content process invokes (step 320) an API process (a process run by the application engine (120) pursuant to the processing of the API source file), which configures the application engine's (120) security settings to allow the third party ad server (308) to serve ads into the content (step 330). The API process may query the third party ad server (308) or some other server to discover which potential ad serving domains are in need of security clearance.

Upon establishing the proper security settings, the content process (304) calls the API process (302) to request the ad (step 340). In response, the API process (302) sends (step 350) the ad request (124) to the ad server (308), which returns (step 360) the requested ad source file (135)—which is formatted for display within the same presentation environment as the content—in the ad response (126). Once received by the application engine (120), the API process (302) serves to act as a communication interface between the content process (304) and the ad process (306).

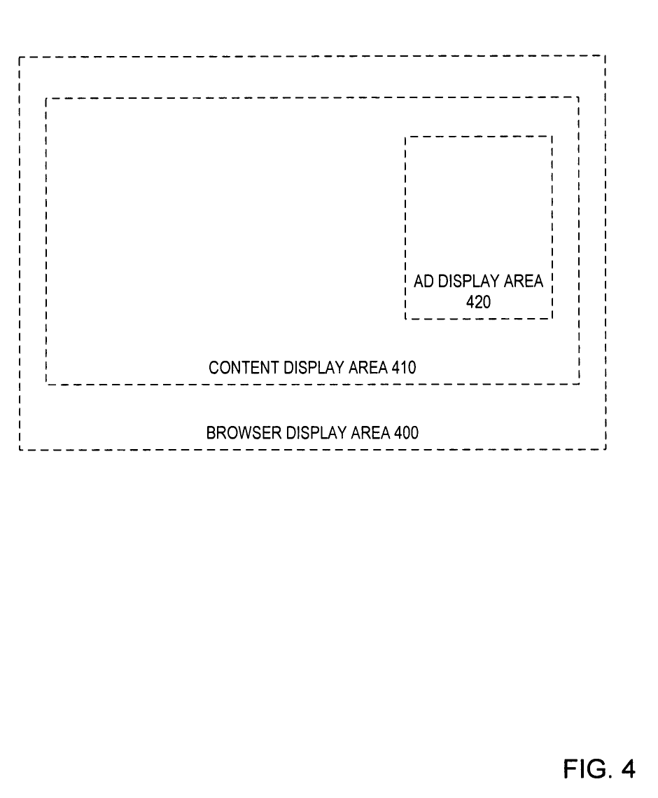

FIG. 4 illustrates that in accordance with an embodiment of the invention, application engine (120) may display the content in an area (410) within the displayable area of the browser (400), and that it may display the ad within an area (420) bound by that (410) of the content display. During the processing of the ad and content source files, the content display may cover as much or as little of the browser display area (400) at any time, and the ad display may cover as much or as little of the content display area (410) at any time.

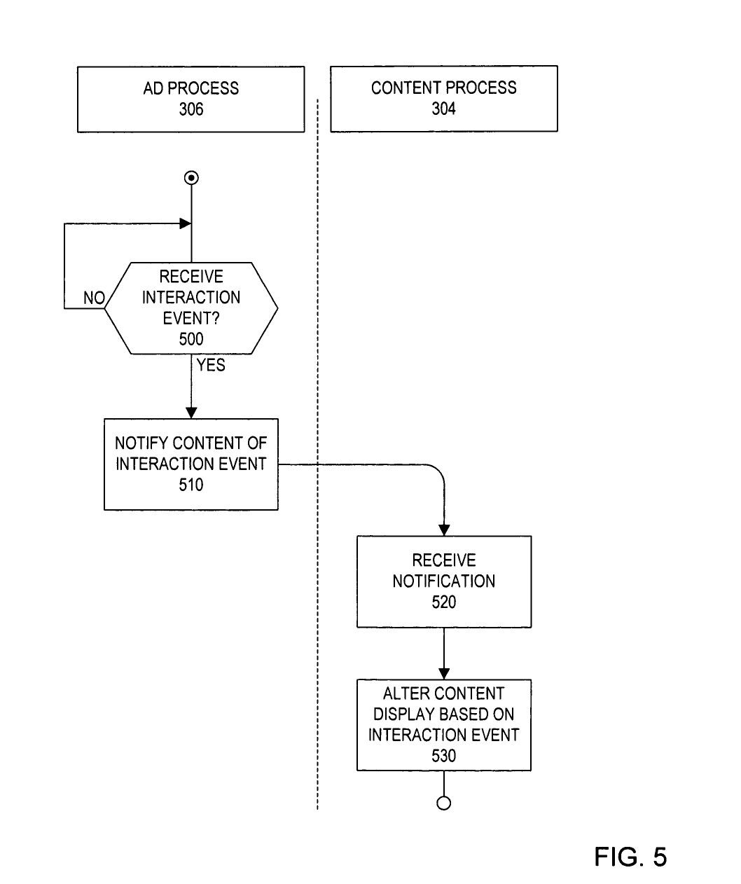

Because the ad and content are processed by the application engine (120) within the same presentation environment, the ad and content are able to directly communicate with each other via a pre-defined API, in or not in conjunction with the API process described above, and alter the ad and/or content displays programmatically. FIGS. 5-10 illustrate several embodiments of this capability. In the following embodiments, the functionality associated with the ad process (306) may in part or whole be implemented by or in conjunction with the API process.

In FIG. 5, the ad process (306) listens for a user interaction event associated with the ad display (step 500). When such an event occurs, the ad process (306) notifies the content process (304) of the event (step 510). Upon receiving the notification (step 520), the content process (304) alters the content display based on the interaction event (step 530).

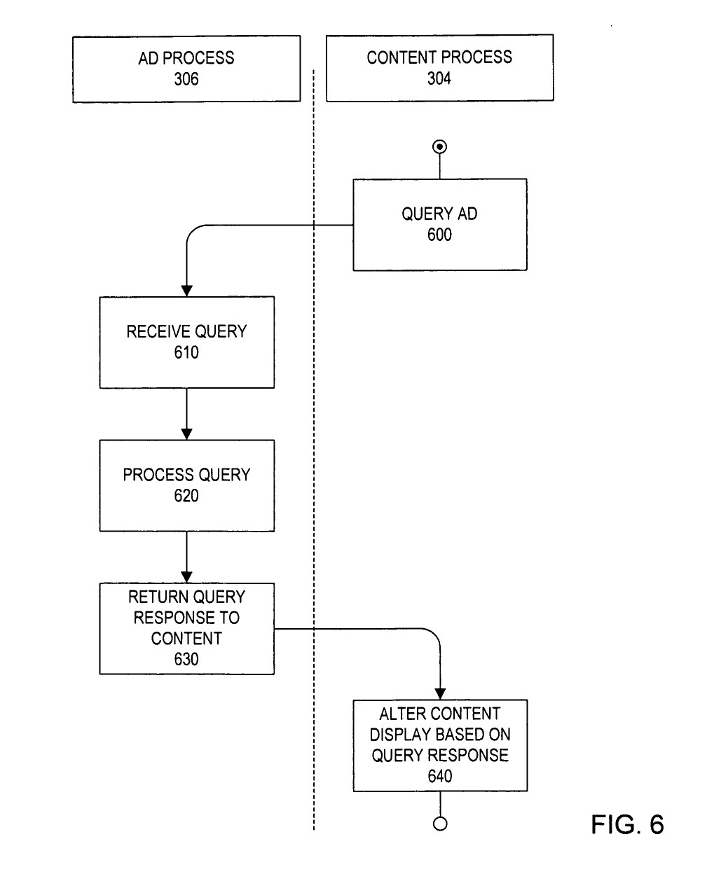

For example, when the content process (304) receives notification of a mouse-over event (i.e., when the user rolls the mouse over the ad display area), it can pause the content (if animated) or alter any text in the content display, such as changing all “s”s to “$”s if the ad relates to the financial services industry. (The content process (304) can determine the field to which the ad is related by querying the ad process (306) as described below in connection with FIG. 6.)

In FIG. 6, the content process (304) queries the ad process (306) for information associated with the ad (step 600). Upon receiving the query request (step 610), the ad process (306) processes the query (step 620) and returns a query response (step 630) to the content process (304). Upon receiving the query response, the content process (304) alters the content display based on the query response (step 640).

For example, the content process (304) could query the ad process (306) to determine ad metadata (e.g., pixel dimension), so that the content process (304) can adjust the content accordingly when the ad is to be displayed.

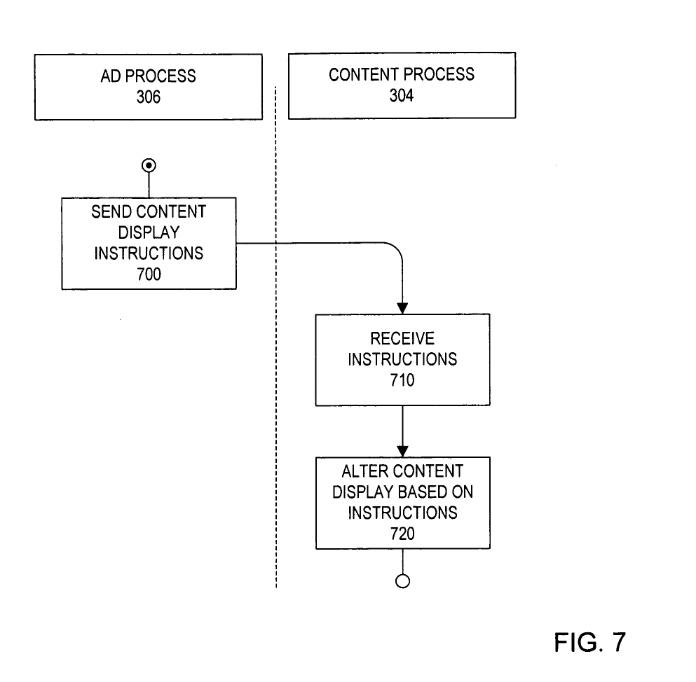

In FIG. 7, the ad process (306) sends content display instructions (step 700) to the content process (304), which, upon receipt (step 710), alters the content display based on the received instructions (step 720). For example, the ad process (306) could command the content process (304) to behave in a certain manner (e.g., blink, pause, etc.) at any time, even if unrelated to a user interaction event.

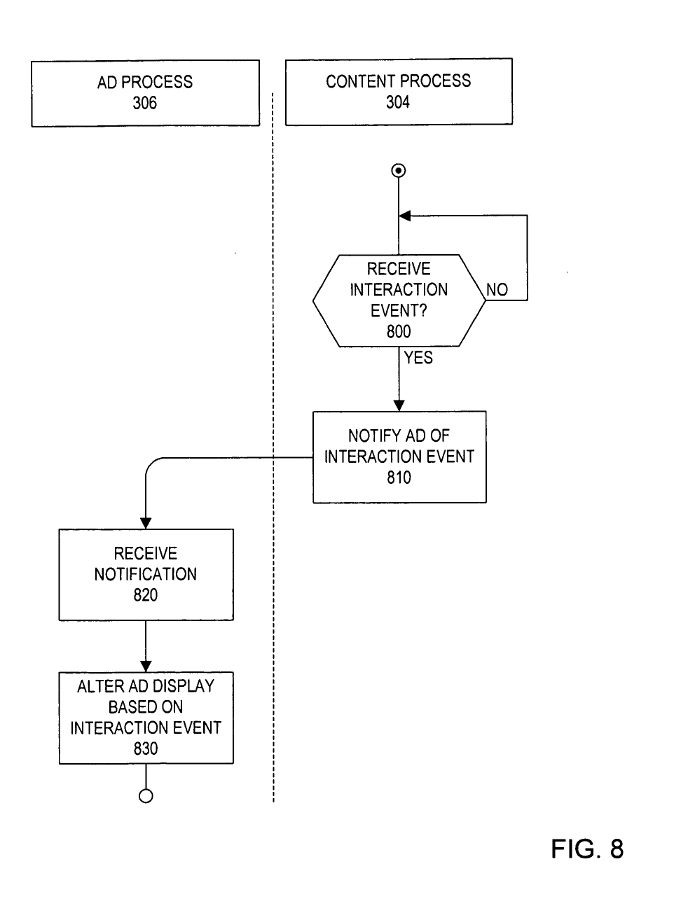

In FIG. 8, the content process (304) listens for a user interaction event associated with the content display (step 800). When such an event occurs, the content process (304) notifies the ad process (306) of the event (step 810). Upon receiving the notification (step 820), the ad process (306) alters the ad display based on the interaction event (step 830). For example, when the content process (304) receives notification of a mouse-over event (i.e., when the user rolls the mouse over the a particular portion of the content display area), it can expand or contract the ad display.

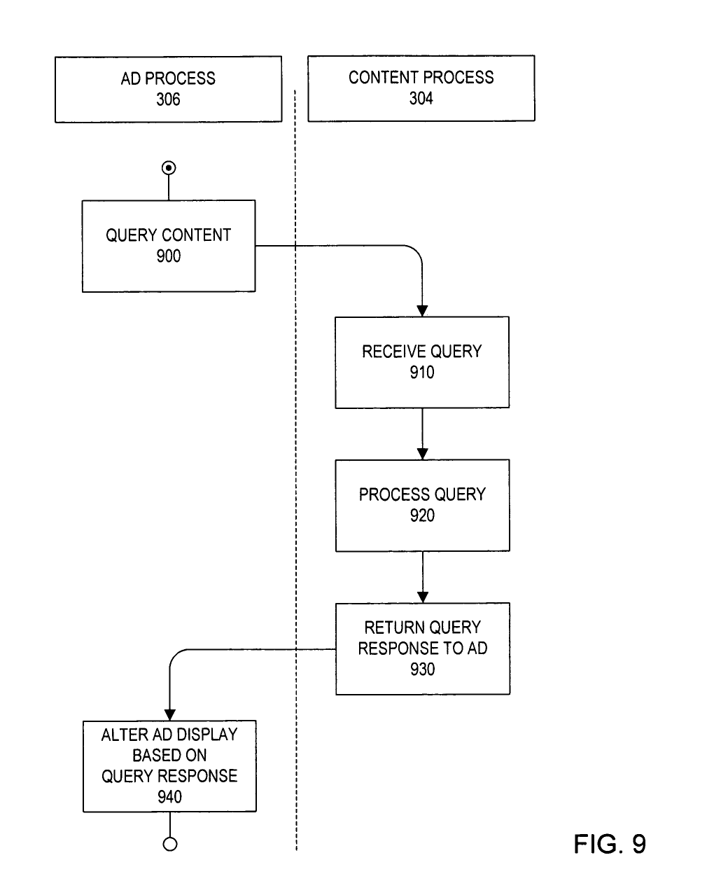

In FIG. 9, the ad process (306) queries the content process (304) for information associated with the content (step 900). Upon receiving the query request (step 910), the content process (304) processes the query (step 920) and returns a query response (step 930) to the ad process (306). Upon receiving the query response, the ad process (306) alters the ad display based on the query response (step 940).

For example, the ad process (306) could query the content process (304) to determine what type of action or coloring is being rendered in the content display, so that the ad process (306) can adjust the ad presentation accordingly so as not to visually conflict with the content.

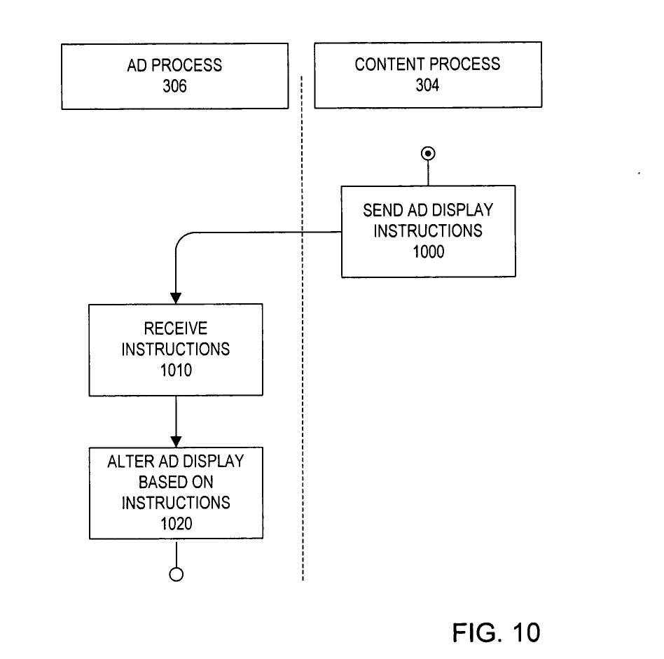

In FIG. 10, the content process (304) sends ad display instructions (step 1000) to the ad process (306), which, upon receipt (step 1010), alters the ad display based on the received instructions (step 1020). For example, the content process (304) could command the ad process (306) to behave in a certain manner (e.g., blink, pause, etc.) at any time, even if unrelated to a user interaction event. As another example, the content process (304) could command the ad process (306) to load in accordance with specific timing, so that the ad and content can appear instantly to the user (rather than having content displayed before the ad due to network latency).

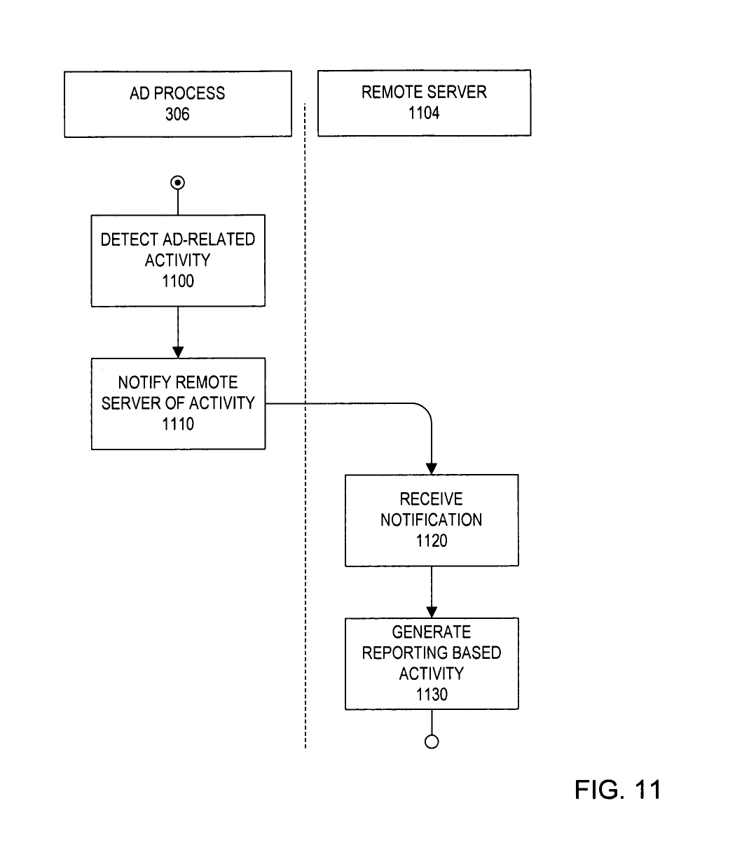

FIG. 11 illustrates that the ad is not restricted to reporting ad-related activity to just the ad server (130) from where it originated. Once the ad process (306) detects ad-related activity (step 1100), it notifies a remote server (1104) identified in the ad source file (135) of the activity (step 1110). Upon receipt of the notification (step 1120), the remote server (1104) may generate reporting based on the received activity (step 1130). Reporting may include any quantifiable event that can be detected by the ad process (306), such as standard metrics (e.g., impressions, interactions, clicks, etc.), counters, timers, visible time, mouse-overs, and elapsed mouse-over time.

In accordance with an embodiment of the invention utilizing the Adobe Flash Player as the application engine (120), the content source file (115), ad source file (135) and API source file may all be provided in SWF format. Once loaded by the application engine (120), their associated processes may function as described above based on the programming (e.g., in ActionScript) provided in the respective source files. Any API specifying any desired function calls may be implemented in order to provide a communication channel between the ad process (306), content process (304) and/or API process.

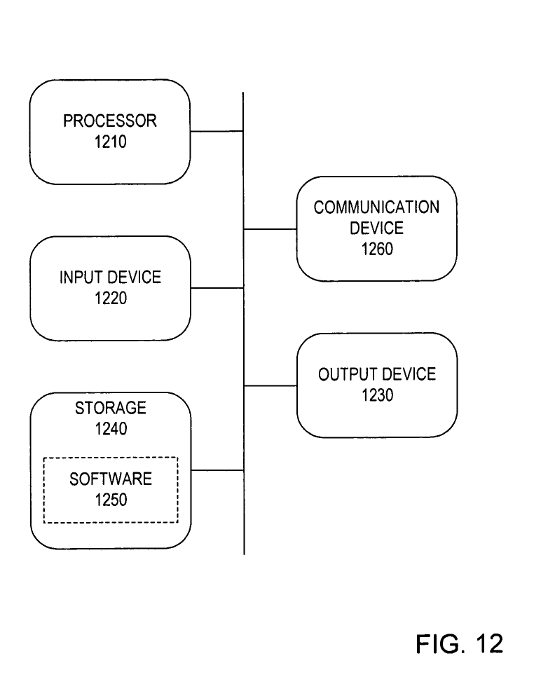

FIG. 12 illustrates the components of a basic computing device in accordance with an embodiment of the present invention, which may include the content provider (110), ad server (130) and the user computer running the web browser (100) and application engine (120). The computing device may be a personal computer, workstation, server, or any other type of microprocessor-based device. The computing device may include one or more of a processor (1210), input device (1220), output device (1230), storage (1240), and communication device (1260).

The input device (1220) may include a keyboard, mouse, pen-operated touch screen or monitor, voice-recognition device, or any other device that accepts input. The output device (1230) may include a monitor, printer, disk drive, speakers, or any other device that provides output.

The storage (1240) may include volatile and nonvolatile data storage, including one or more electrical, magnetic or optical memories such as a RAM, cache, hard drive, CD-ROM drive, tape drive or removable storage disk. The communication device (1260) may include a modem, network interface card, or any other device capable of transmitting and receiving signals over a network. The components of the computing device may be connected in any manner, such as via electrical bus or wirelessly.

The software (1250), which may be stored in the storage (1240) and executed by the processor (1210), may include, for example, the application programming that embodies the functionality of the present invention (e.g., as embodied in the content source file (115) or ad source file (135)).

Communications may occur over any type of network (such as the Internet (102) for example), which may implement any communications protocol, which may be secured by any security protocol. Network links may include telephone lines, DSL, cable networks, T1 or T3 lines, wireless network connections, or any other arrangement that implements the transmission and reception of network signals.

The computing device may implement any operating system, such as Windows, Mac OS, Linux or UNIX. The software (1250) may be written in any programming language, such as C, C++, lava, Visual Basic, ActionScript and/or SQL.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software that implements the present invention such as that embodied in content source file (115) or ad source file (135) may be spread across several files that together still provide the same functionality, and the data and flow diagrams of FIGS. 1-2 and 5-11 may encompass combined steps or several intermediate steps that do not detract from the higher level functionality described therein.

In other embodiments, the application engine (120) need not be embedded within a web browser (100), but may act as a standalone application with its own connection to the Internet (102), content provider (110) and ad server (130). In such an embodiment, the application engine (120) would directly request and receive the content source file (115) from the content provider (110) prior to processing it, rather than being invoked by a browser (100) to process content referenced by a web page.

What is claimed is:

1. A method of serving ads, comprising:
receiving by an ad server over a network an ad request issued by an application engine on a user computer, the ad request issued by the application engine
in connection with processing a content source file specifying in a format required by the application engine how the application engine is to provide a display of content, and
subsequent to the application engine configuring a security setting of the application engine to allow the ad server to serve one or more ads into the content display; and
providing an ad source file over the network to the user computer in response to the ad request, the ad source file specifying in the required application engine format how the application engine is to provide a display of an ad.

2. The method of claim 1, wherein a process associated with the application engine's processing of the content source file:
receives an instruction or data from a process associated with the application engine's processing of the ad source file, and
alters the content display based on the received instruction or data.

3. The method of claim 1, wherein a process associated with the application engine's processing of the ad source file:
receives an instruction or data from a process associated with the application engine's processing of the content source file, and
alters the ad display based on the received instruction or data.

4. A method of serving ads, comprising:
receiving by an ad server over a network an ad request issued by an application engine embedded within a web browser on a user computer, the ad request issued by the application engine in connection with processing a content source file, the content source file having been received by the user computer over the network from a content provider and specifying in a format required by the application engine how the application engine is to provide a display of content; and
providing an ad source file over the network to the user computer in response to the ad request, the ad source file specifying in the required application engine format how the application engine is to provide a display of an ad.

5. The method of claim 4, wherein the application engine and the content source file are referenced by a web page processed by the web browser.

6. The method of claim 4, wherein the application engine renders the content display within a displayable area of the web browser.

7. The method of claim 4, wherein the application engine renders the ad display in integration with the content display.

8. The method of claim 4, further comprising:
receiving by the ad server over the network a configuration request issued by the application engine in connection with processing the content source file; and
providing an configuration source file over the network to the user computer in response to the configuration request, the configuration source file specifying in the required application engine format how the application engine is to grant security access to permit downloading of the ad source file from the ad server.

9. The method of claim 4, further comprising:
receiving by the ad server over the network an API request issued by the application engine in connection with processing the content source file; and
providing an API source file over the network to the user computer in response to the API request, the API source file specifying in the required application engine format how the application engine is to instantiate a process to facilitate communication in accordance with a pre-defined API between a process associated with the application engine's processing of the content source file and a process associated with the application engine's processing of the ad source file.

10. The method of claim 4, wherein a process associated with the application engine's processing of the content source file:
receives notification of a user interaction event associated with the ad display from a process associated with the application engine's processing of the ad source file, and
alters the content display based on the event.

11. The method of claim 4, wherein a process associated with the application engine's processing of the content source file:
queries a process associated with the application engine's processing of the ad source file for information associated with the ad,
receives a response from the queried process with the requested information, and
alters the content display based on the received information.

12. The method of claim 4, wherein a process associated with the application engine's processing of the content source file:
receives one or more instructions from a process associated with the application engine's processing of the ad source file, and
alters the content display based on the one or more received instructions.

13. The method of claim 4, wherein a process associated with the application engine's processing of the ad source file:
receives notification of a user interaction event associated with the content display from a process associated with the application engine's processing of the content source file, and
alters the ad display based on the event.

14. The method of claim 4, wherein a process associated with the application engine's processing of the ad source file:
queries a process associated with the application engine's processing of the content source file for information associated with the content,
receives a response from the queried process with the requested information, and
alters the ad display based on the received information.

15. The method of claim 4, wherein a process associated with the application engine's processing of the ad source file:
receives one or more instructions from a process associated with the application engine's processing of the content source file, and
alters the ad display based on the one or more received instructions.

16. The method of claim 4, further comprising:
receiving by the ad server over the network reporting information in connection with usage of the ad from a process associated with the application engine's processing of the ad source file.

17. The method of claim 4, wherein a server other than the ad server receives over the network reporting information in connection with usage of the ad from a process associated with the application engine's processing of the ad source file.

18. The method of claim 4, wherein the application engine renders Adobe Flash source files.

19. The method of claim 4, wherein the required application engine format is SWF.

20. A system for serving ads, comprising:
an application engine embedded within a web browser on a user computer;
an ad server accessible to the user computer over a network;
an ad source file communicatively linked to the ad server, the ad source file specifying in a format required by the application engine how the application engine is to provide a display of an ad;
a content provider accessible to the user computer over a network; and
a content source file communicatively linked to the content provider, the content source file specifying in the required application engine format how the application engine is to provide a display of content,
wherein the content provider provides the content source file over the network to the user computer,
wherein the application engine, in connection with processing the content source file, issues an ad request over the network to the ad server, and
wherein the ad server provides the ad source file over the network to the user computer in response to the ad request.
